(19) United States
(12) Patent Application Publication
(10) Pub. No.: US 2023/0066440 A1
(43) Pub. Date: Mar. 2, 2023

(54) AUTO CLOSING OF INPUT DEVICE OR OUTPUT DEVICE

(71) Applicant: HEWLETT-PACKARD DEVELOPMENT COMPANY, L.P., Spring, TX (US)

(72) Inventors: Jaewon CHOI, Seongnam-si, Gyeonggi-do (KR); Hyunkyu PARK, Seongnam-si, Gyeonggi-do (KR); Yosup PARK, Seongnam-si, Gyeonggi-do (KR)

(21) Appl. No.: 17/793,453

(22) PCT Filed: Oct. 26, 2020
(86) PCT No.: PCT/US2020/057318

§ 371 Date: Jul. 18, 2022

(30) Foreign Application Priority Data
Jan. 22, 2020 (KR) 10-2020-0008508

(51) Int. Cl. F16H 25/14; B41J 29/13

(52) U.S. Cl. CPC F16H 25/14; B41J 29/13

(57) ABSTRACT

An example auto closing apparatus may include a holder, a cam member to rotate, according to a movement of the holder, between a lock position at which the holder is inserted and an unlock position at which the holder is discharged, and an elastic member to provide a restoring force to rotate the cam member to rotate between the unlock position and the lock position.

### BACKGROUND

An image forming apparatus may perform various operations, such as generating, printing, receiving, or transmitting of image data. Examples of an image forming apparatus include a printer, a scanner, a copy machine, a fax machine, and a multifunction printer integrating these functions. Various types of input/output devices, such as a display device, a touch screen device, or a keyboard, may be included with the image forming apparatus to increase user convenience.

### BRIEF DESCRIPTION OF THE DRAWINGS

Various examples will be described below by referring to the following figures.

FIG. 1 is a perspective view of an auto closing apparatus of an input/output device according to an example.

FIG. 2 is an exploded perspective view of an auto closing apparatus of an input/output device according to an example.

FIG. 3 is a perspective view of a main body of an auto closing apparatus of an input/output device according to an example.

FIG. 4 is a partial cross-sectional view of a main body of an auto closing apparatus of an input/output device according to an example.

FIG. 5 is a partial perspective view of a main body of an auto closing apparatus of an input/output device according to an example.

FIG. 6 and FIG. 7 are perspective views of a holder of an auto closing apparatus of an input/output device according to an example.

FIG. 8 is a perspective view of a left side guide plate of an auto closing apparatus of an input/output device according to an example.

FIG. 9 is a perspective view of a right side guide plate of an auto closing apparatus of an input/output device according to an example.

FIG. 10 is a perspective view of a cam member of an auto closing apparatus of an input/output device according to an example.

FIG. 11 is a top plan view of a cam member of an auto closing apparatus of an input/output device according to an example.

FIG. 12 is a perspective view of an elastic member of an auto closing apparatus of an input/output device according to an example.

FIG. 13 to FIG. 16 illustrate an operation of an auto closing apparatus of an input/output device according to an example.

FIG. 17 is a perspective view of an auto closing apparatus of an input/output device according to an example.

FIG. 18 is an exploded perspective view of an auto closing apparatus of an input/output device according to an example.

FIG. 19 is a perspective view of a main body of an auto closing apparatus of an input/output device according to an example.

FIG. 20 is a perspective view of a holder of an auto closing apparatus of an input/output device according to an example.

FIG. 21 and FIG. 22 are respective views of a connection frame according to an example.

FIG. 23 to FIG. 28 illustrate an operation of an auto closing apparatus of an input/output device according to an example.

### DETAILED DESCRIPTION

Hereinafter, various examples will be described with reference to the drawings. Like reference numerals in the specification and the drawings denote like elements, and thus a redundant description may be omitted.

The terminology used herein is for the purpose of describing examples and is not intended to be limiting of the disclosure. As used herein, the singular forms are intended to include the plural forms as well, unless the context clearly indicates otherwise. As used herein, the term “comprises” and/or “comprising” refers to the presence of specified features, integers, steps, acts, operations, elements, and/or components, but it should also be understood that it does not exclude the presence or an addition of another feature, integer, step, act, operation, component, and/or group thereof. As used herein, the term “and/or” includes any one or all combinations of one or more related items. The term “coupled” denotes a physical relationship between two components in which components are directly connected to each other or indirectly connected to each other through one or more intermediary components.

Various types of input/output devices, such as a display device, a touch screen device, or a keyboard, may be included with an image forming apparatus to increase user convenience.

Although such an input/output device may be fixedly attached to an exterior of a main body of the image forming apparatus, it is generally designed to be hidden into an interior of the main body when not used, in consideration of an aesthetic factor.

Hereinafter, an auto closing apparatus of an input/output device according to an example is disclosed with reference to accompanying drawings.

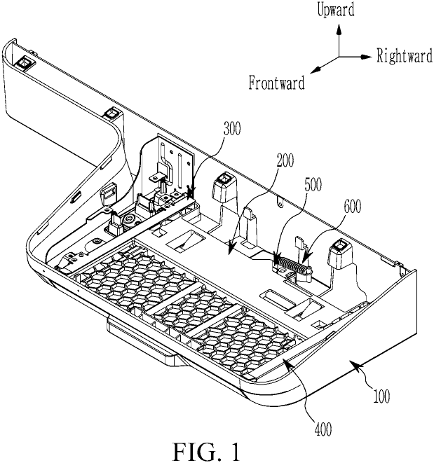

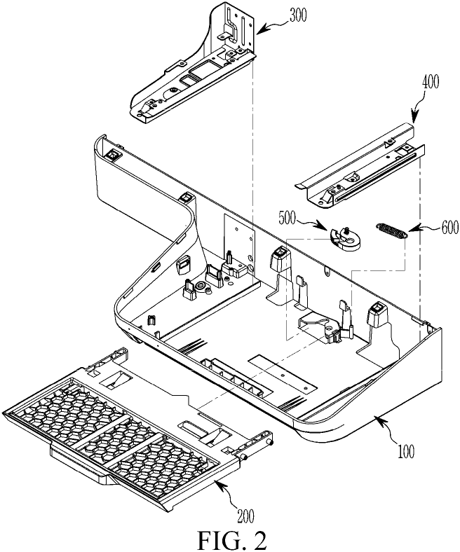

FIG. 1 is a perspective view of an auto closing apparatus of an input/output device according to an example. FIG. 2 is an exploded perspective view of an auto closing apparatus of an input/output device according to an example.

Referring to FIG. 1 and FIG. 2, an auto closing apparatus of an input/output device may be coupled to an interior of a main body 100 of an image forming apparatus. The image forming apparatus may include a printer, a scanner, a copy machine, a fax machine, or a multifunction printer in which their functions are integrated. The main body 100 may form an appearance of the image forming apparatus, and may enclose a printing medium supply apparatus, a printing apparatus, a fusing apparatus, a printing medium discharge apparatus, or the like.

Example input/output devices of an image forming apparatus may include a display device, a touch screen device, a keyboard, a card reader, a security module, or the like, provided for convenience of a user.

The auto closing apparatus may include a holder 200 on which an input/output device may be disposed, a cam member 500 to rotate about a hinge according to a movement of the holder 200, and an elastic member 600 to provide an elastic force to the cam member 500.

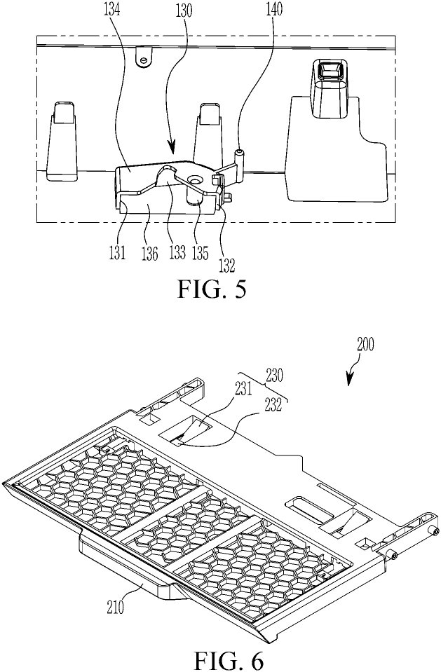

The holder 200 may be discharged to an exterior of the main body 100 or may be inserted into the main body 100 through an inlet 110 (refer to FIG. 4) coupled to the main body 100 of the image forming apparatus. In an example, a direction in which the holder 200 is discharged out of the main body 100 through the inlet 110 is called a discharge direction (or, frontward), and a direction in which the holder 200 is inserted into the main body 100 through the inlet 110 is called a feeding direction (or, rearward).

The above-described input/output device may be seated on the holder 200, and the input/output device may be fixedly coupled to or detachably coupled to the holder 200. Alternatively, the holder 200 may be integrally formed with a lower part of the input/output device. In an example, the input/output device is detachably seated on the holder 200.

The holder 200 may be guided by a pair of guide members coupled to the main body 100. The pair of guide members may include a left side guide plate 300 and a right side guide plate 400 to guide both ends of holder 200.

Hereinafter, respective constituent elements in an auto closing apparatus according to an example will be described.

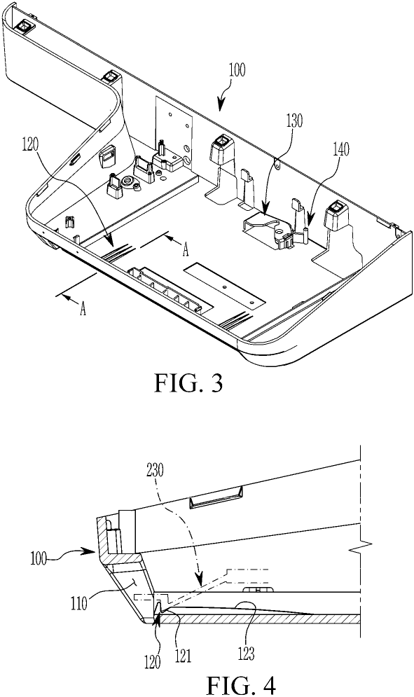

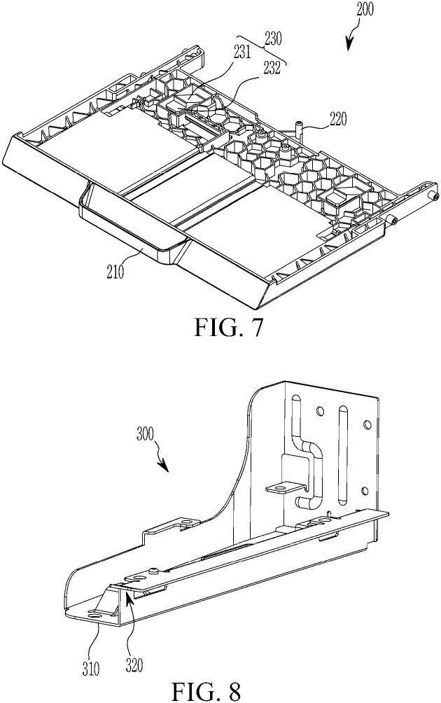

FIG. 3 is a perspective view of a main body of an auto closing apparatus of an input/output device according to an example. FIG. 4 is a partial cross-sectional view of a main body of an auto closing apparatus of an input/output device according to an example. FIG. 5 is a partial perspective view of a main body of an auto closing apparatus of an input/output device according to an example.

Referring to FIG. 3, an auto closing apparatus may be coupled to an interior of the main body 100, and the inlet 110 may be coupled to the main body 100. The holder 200 of the auto closing apparatus may be fed or inserted through the inlet 110.

Referring to FIG. 4, a stopper groove 121 may be provided on a bottom surface of the main body 100. The stopper groove 121 cooperates with a stopper hook 230 to perform a function as a limiter for limiting a discharge amount of the holder 200. A pair of stopper grooves 121 may be provided on both sides of a center of the bottom surface of the main body 100. The stopper groove 121 may be provided on a stopper body 120 protruding from the bottom surface of the main body 100, and a slanted surface 123 having a gradually decreasing height may be provided at a rear of the stopper body 120.

Referring back to FIG. 3, a cam housing 130 may be provided at a rear in the main body 100. The cam housing 130 may guide a rotation of the cam member 500 and may perform a function as a limiter for limiting a rotation amount of the cam member 500. Referring to FIG. 5, the cam housing 130 protrudes upward from a bottom surface of the main body 100, and may include a pair of housing sidewalls including a housing left sidewall 131 and a housing right sidewall 132, a housing rear wall 133 connecting the pair of housing sidewalls, and a housing upper surface 134 covering the pair of housing sidewalls and the housing rear wall 133. An open housing inlet 136 is provided between the pair of housing sidewalls such that the cam member 500 may be inserted into the cam housing 130. A hinge boss 135 for hinged coupling of the cam member 500 may be coupled to the housing upper surface 134 of the cam housing 130. As such, the cam member 500 may rotate inside the cam housing 130, and thus the cam member 500 may stably rotate without shaking.

In addition, for coupling of the elastic member 600, a main body catching protrusion 140 may protrude on the bottom surface of the main body 100, and the main body catching protrusion 140 may be provided adjacent to the cam housing 130. The main body catching protrusion 140 may have a cylindrical shape, and a catching groove (not shown) may be coupled to the main body catching protrusion 140 so as to catch an end of the elastic member 600.

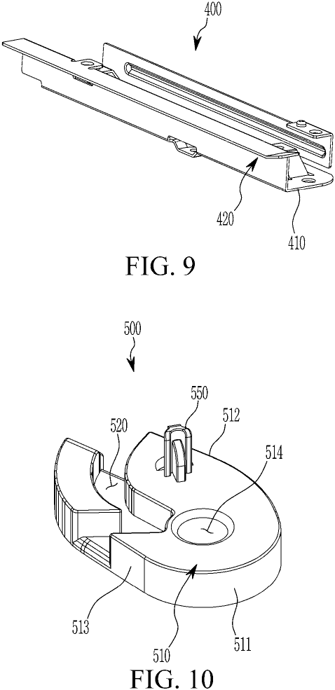

FIG. 6 and FIG. 7 are perspective views of a holder of an auto closing apparatus of an input/output device according to an example.

As shown in FIG. 6 and FIG. 7, the holder 200 may have a generally planar shape, and a handle 210 may be provided at the front center of the holder 200. For a user’s convenience, a length of the handle 210 may be determined such that the handle 210 may protrude out of the main body 100 in a state in which the holder 200 is fully inserted into the main body 100 of the image forming apparatus. The user may grasp the handle 210 to pull the holder 200 out of the main body 100, or to push the holder 200 into the interior of the main body 100.

In the rear center of the holder 200, the holder boss 220 may be provided to extend in the downward direction. The holder boss 220 may be have a cylindrical shape. The holder boss 220 may rotate the cam member 500 in cooperation with a cam path coupled to the cam member 500. The cam path may be coupled to the cam member 500 such that the cam member 500 is rotated by the holder boss 220 when the holder 200 moves straightly frontward and rearward. That is, the cam path of the cam member 500 converts the straight line movement of the holder boss 220 of the holder 200 into the rotational movement of the cam member 500.

A pair of stopper hooks 230 may be provided on both sides of a center of the holder 200. The pair of stopper hooks 230 may be provided at positions symmetrical to each other with respect to the holder boss 220. The stopper hook 230 may limit a discharged amount of the holder 200 when the holder 200 is discharged out of main body 100. That is, the stopper hook 230 of the holder 200 may cooperate with the stopper groove 121 provided at a bottom of the main body 100 to limit the discharge amount of the holder 200.

The stopper hook 230 may be provided to be elastically operable in both up and down directions at both sides of a center of the holder 200. For example, the stopper hook 230 may be provided to elastically operate at an end of the opening formed in the holder 200. The stopper hook 230 may include a first slant part 231 extending frontward and downward at an end of the opening and a second slant part 232 extending frontward and upward at an end of the first slant part 231.

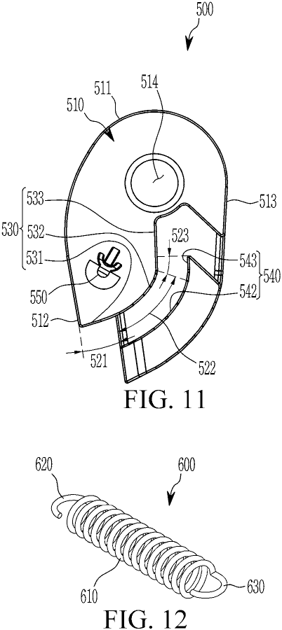

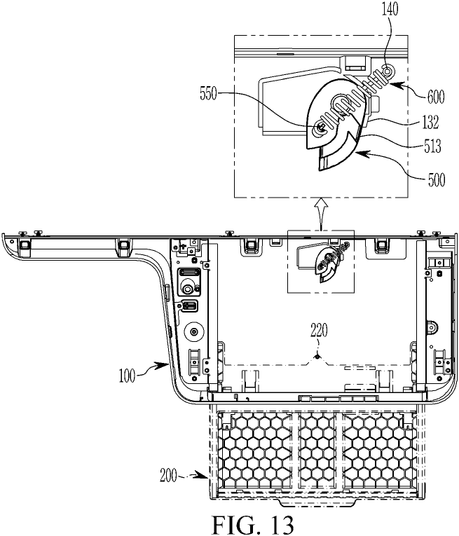

FIG. 8 is a perspective view of a left side guide plate of an auto closing apparatus of an input/output device according to an example. FIG. 9 is a perspective view of a right side guide plate of an auto closing apparatus of an input/output device according to an example.

Referring to FIG. 8, the left side guide plate 300 is for guiding the left side end of the holder 200, and may include a left side body 310 to couple with the bottom surface of the main body 100 and a left guide part 320 bent upward from the end of the left side body 310. The left guide plate 300 may be manufactured by pressing a metal plate.

Referring to FIG. 9, the right side guide plate 400 is for guiding a right side end of the holder 200, and may include a right side body 410 to couple with the bottom surface of the main body 100 and a right guide part 420 bent upward from the end of the right side body 410. The right side guide plate 400 may be manufactured by pressing a metal plate.

The left guide part 320 and the right guide part 420 may have shapes symmetrical to each other, and a fastening hole for screwed engagement with the main body 100 may be provided in each of the guide plates 300 and 400, respectively. In an example, the guide member is described to be provided as a separate component from the main body 100, but the guide member may also be integrally formed with the main body 100.

The left side end of the holder 200 may be inserted into the left guide part 320, and the right side end of the holder 200 may be inserted into the right guide part 420, such that, when the holder 200 moves in the frontward and rearward directions, the pair of guide members may stably move the holder 200 in the frontward and rearward directions.

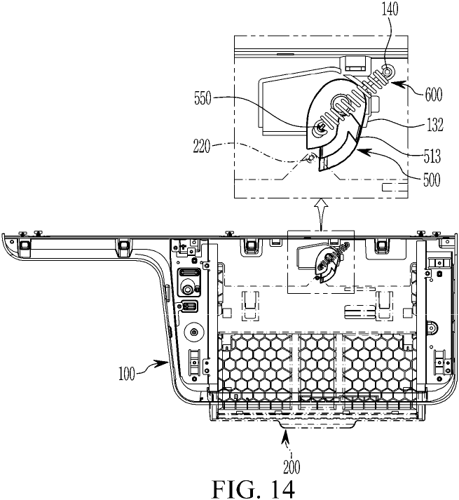

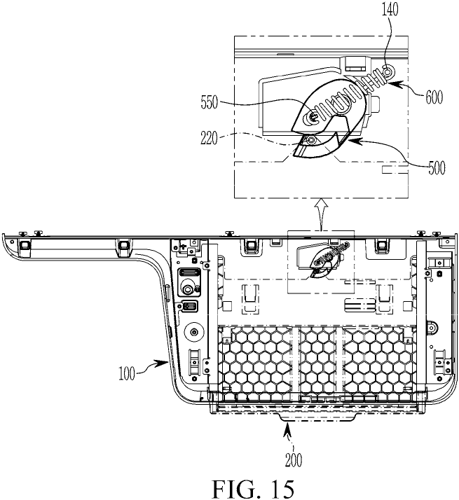

FIG. 10 is a perspective view of a cam member of an auto closing apparatus of an input/output device according to an example. FIG. 11 is a top plan view of a cam member of an auto closing apparatus of an input/output device according to an example.

As shown in FIG. 10 and FIG. 11, the cam member 500 may include a cam body 510, a hinge hole 514 provided in the cam body 510, a cam path 520 provided in the cam body 510, and a cam catching protrusion 550 coupled to the cam body 510.

The cam body 510 may include a cam rotation part 511 of a generally semicircular shape, a cam left sidewall 512 extending on the left side end of the cam rotation part 511, and a cam right sidewall 513 extending on the right side end of the cam rotation part 511. The cam left sidewall 512 and the cam right sidewall 513 may cooperate with the cam housing 130 to operate as a limiter to limit the rotation of the cam member 500.

The hinge hole 514 provided in the cam body 510 may be provided at a position coincident with a center of the cam rotation part 511. The hinge hole 514 may be inserted into the hinge boss 135 of the cam housing 130 coupled to the main body 100 such that the cam member 500 may rotate about the hinge boss 135.

The cam member 500 may rotate about the hinge boss 135 reciprocally rotates between a lock position in which the holder 200 is inserted into the main body 100 and an unlock position in which the holder 200 is discharged out of the main body 100. A position at which the elastic force of the elastic member 600 is maximized (or, a position at which an extended amount of the elastic member 600 is maximum) between the lock position and the unlock position is called a neutral position. The neutral position may be positioned at a center between the lock and unlock positions. However, if necessary, the neutral position may be positioned at another position between the lock position and the unlock position.

In an example, a direction in which the cam member 500 rotates from the unlock position to the lock position is called a locking direction (e.g., clockwise with reference to FIG. 11), and a direction in which the cam member 500 rotates from the lock position to the unlock position Is called an unlocking direction (e.g., counter-clockwise with reference to FIG. 11).

Referring to FIG. 11, a feeding range 521, a curved range 522, and a straight range 523 may be continuously provided in the cam path 520. The feeding range 521 may be provided such that a cam left surface is opened at an end and inclined at a predetermined angle toward the hinge hole 514, the curved range 522 is rounded at an end of the feeding range 521 to have a predetermined radius toward the hinge hole 514, and the straight range 523 may extend at an end of the curved range 522 toward the hinge hole 514.

The feeding range 521, the curved range 522, and the straight range 523 forming the cam path 520 may be provided by a cam wall 530 and a guide surface 540 provided on the cam body 510.

The cam wall 530 may include a cam feeding surface 531 provided such that the cam left sidewall 512 is inclined at a predetermined angle toward the hinge hole 514, a cam curved surface 532 rounded at an end of the cam feeding surface 531 to have a predetermined radius toward the hinge hole 514, and a cam flat surface 533 extending at an end of the cam curved surface 532 toward the hinge hole 514.

The guide surface 540 may include a guide curved surface 542 having a radius corresponding to the cam curved surface 532 and a guide flat surface 543 provided correspondingly to the cam flat surface 533. The end of the cam feeding surface 531 (or, the end of the cam left sidewall) and the end of the guide surface 540 are disposed to be spaced apart by a predetermined distance such that a hinge of the holder 200 may move toward the cam feeding surface 531. That is, the feeding range 521 of the cam path 520 may be provided to be open.

One end of the elastic member 600 may be coupled to the cam catching protrusion 550 provided on the cam body 510. The cam catching protrusion 550 may be provided between the hinge hole 514 and the end of the cam left surface.

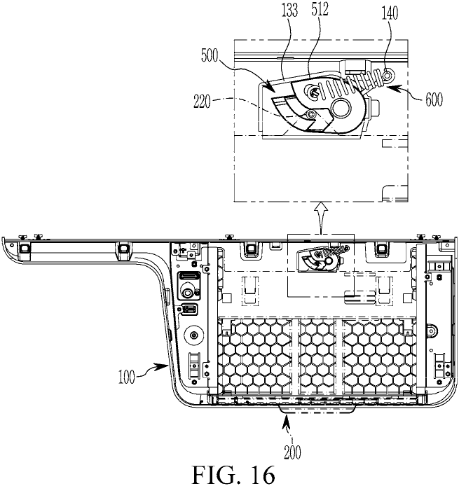

FIG. 12 is a perspective view of an elastic member of an auto closing apparatus of an input/output device according to an example.

Referring to FIG. 12, the elastic member 600 may be realized as a coil spring. In this case, the coil spring may be a tension coil spring. However, this is merely an example and the elastic member 600 may be realized as various types of springs that may provide a predetermined elastic force (or restoring force) to the cam member 500.

The elastic member 600 may include a spring body 610 to provide an elastic force, a first catching ring 620 provided at one end of the spring body 610, and a second catching ring 630 provided at an opposite end of the spring body 610.

The first catching ring 620 may be caught by the main body catching protrusion 140 coupled to the main body 100, and the second catching ring 630 may be caught by the cam catching protrusion 550 coupled to the cam member 500 such that the elastic force of the elastic member 600 is applied to the cam member 500. As an extended length of the elastic member changes according to the rotation of the cam member, the elastic force applied to the cam member 500 (or, the restoring force of the elastic member to rotate the cam member) changes.

For example, when the cam member 500 is in the lock position, the extended amount of the elastic member 600 is reduced or minimized, and the restoring force of the elastic member 600 is reduced or becomes a minimum. When the cam member 500 rotates from the lock position in the unlocking direction and reaches the neutral position, the extended amount of the elastic member 600 increases or becomes a maximum and the restoring force of the elastic member 600 increases or becomes a maximum. As an example, the elastic member 600 may provide a first restoring force at the lock position and the unlock position and a second restoring force at the neutral position between the lock position and the unlock position, wherein the second restoring force is greater than the first restoring force. Thereafter, when the cam member 500 further rotates in the unlocking direction and the cam member 500 reaches the unlock position, the extended amount of the elastic member 600 is reduced or becomes minimum again and the restoring force of the elastic member 600 is reduced or becomes a minimum. Therefore, when the cam member 500 is out of the neutral position, the cam member 500 is rotated to the lock position or the unlock position by the restoring force of the elastic member 600.

Hereinafter, an assembly process of an auto closing apparatus according to an example will be described.

The pair of guide members including the left side guide plate 300 and the right side guide plate 400 may be combined with the main body 100. After the left side body 310 of the left side guide plate 300 and the right side body 410 of the right side guide plate 400 are seated on the bottom surface of the main body 100, the bottom surface of the main body 100 and the respective guide plates 300 and 400 may be screw-fastened through fastening holes provided in the left side body 310 and the right side body 410.

The cam member 500 may be coupled to the cam housing 130. The cam housing 130 may be coupled to the main body 100 having the bottom surface opened, and the housing inlet 136 may be opened. Therefore, the cam member 500 may be coupled to the interior of the cam housing 130 by fitting the hinge hole 514 of the cam member 500 to the hinge boss 135 after inserting the cam member 500 into the cam housing 130 through the housing inlet 136 at a state inclined a predetermined angle downward.

The elastic member 600 may be coupled between the cam member 500 and the main body 100. For example, the first catching ring 620 provided on the one end of elastic member 600 may be placed on the catching groove 141 of the main body catching protrusion 140 provided on the main body 100, and the second catching ring 630 may be placed on the cam catching protrusion 550 provided on the cam member 500.

For example, the first catching ring 620 provided at one end of elastic member 600 may be hooked to the catching groove 141 of the main body catching protrusion 140 provided at the main body 100, and the second catching ring 630 may be hooked to the cam catching protrusion 550 provided at the cam member 500.

The holder 200 may be inserted into the main body 100 through the inlet 110. The stopper hook 230 coupled to the holder 200 may be inserted into the main body 100 via the stopper groove 121 of the stopper body 120 provided on the bottom surface of the main body 100. In addition, the holder boss 220 coupled to the holder 200 may be inserted into the inlet 110 of the cam path 520 provided in the cam member 500.

An operation of an auto closing apparatus according to an example will be described. Firstly, an example operation of inserting the holder into the main body while being discharged to the exterior of the main body will be described.

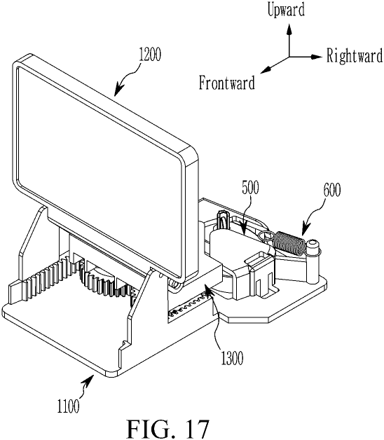

FIG. 13 to FIG. 16 illustrate an operation of an auto closing apparatus of an input/output device according to an example. FIG. 13 illustrates a state in which the holder 200 is fully discharged to the exterior of the main body 100, the cam member 500 is rotated to the unlock position, and the stopper hook 230 of the holder 200 is hooked to the stopper groove 121 provided on the bottom surface of the main body 100. FIG. 14 illustrates a state in which the holder 200 is discharged to the exterior of the main body 100 and the cam member 500 is rotated to the unlock position. FIG. 15 illustrates a state in which the holder 200 is inserted into the main body 100 and the cam member 500 is rotated to the neutral position. FIG. 16 illustrates a state in which the holder 200 is fully inserted into the main body 100 and the cam member 500 is rotated to the lock position.

Referring to FIG. 13 and FIG. 14, when the user grips the handle 210 of the holder 200 and pushes the holder 200 through the inlet 110 of the main body 100, the holder boss 220 of the holder 200 moves toward the feeding range 521 of the cam path 520 provided in the cam member 500.

When the holder 200 moves rearward, the holder boss 220 moves straightly rearward, and by a straight line movement of the holder boss 220 inserted into the cam path 520 the cam member 500 begins to rotate from the unlock position in the locking direction about the hinge hole 514. According to the rotation of the cam member 500, the extended length of the elastic member 600 gradually increases and the restoring force of the elastic member 600 gradually increases.

As the user continues to push the holder 200 into the main body 100, the curved range 522 of the cam path 520 rotates along the holder boss 220.

That is, the cam member 500 rotates in the locking direction and the cam member 500 rotates to the neutral position (refer to FIG. 15). At this time, the elastic member 600 connected to the cam member 500 may be maximally extended such that the restoring force of the elastic member 600 becomes maximum.

When the user continues to push the holder 200 into the main body 100 and thereby the cam member 500 begins to leave the neutral position, the cam member 500 is rotated to the lock position by the restoring force of the elastic member 600. At this time, the holder boss 220 moves to the straight range 523 of the cam path 520, and the cam left sidewall 512 of the cam member 500 reaches the rear wall of the cam housing 130, thereby limiting the rotation of the cam member 500. Therefore, the entering distance of the holder 200 is limited (refer to FIG. 16).

In a case in which the cam member 500 rotates from the unlock position in the locking direction, when the user pushes the holder 200 until the cam member 500 leaves the neutral position, then the holder 200 is inserted into the main body 100 by the restoring force of the elastic member 600.

An example operation of discharging the holder 200 from the interior of the main body 100 to the exterior of the main body 100 through an auto closing apparatus will be described. The example process of discharging the holder 200 from the main body 100 may be performed in a reverse order of the above-described process of inserting the holder 200 into the main body 100.

When the user grips the handle 210 of the holder 200 and pulls the holder 200 out of the main body 100, the cam member 500 begins to rotate from the lock position in the unlocking direction by a straight line movement of the holder boss 220 (refer to FIG. 16). According to the rotation of the cam member 500, the extended length of the elastic member 600 gradually increases and the restoring force of the elastic member 600 gradually increases.

As the user continues to pull the holder 200 out of the main body 100, the curved range 522 of the cam path 520 rotates along the holder boss 220.

That is, the cam member 500 rotates in the unlocking direction and the cam member 500 rotates to the neutral position (refer to FIG. 15). At this time, the elastic member 600 connected to the cam member 500 may be maximally extended such that the restoring force of the elastic member 600 is maximum.

When the user continues to pull the holder 200 out of the main body 100 and thereby the cam member 500 begins to leave the neutral position, the cam member 500 is rotated to the unlock position by the restoring force of the elastic member 600 (refer to FIG. 14). The holder boss 220 moves from the curved range 522 of the cam path 520 to the feeding range 521, and by a centrifugal force due to the rotation of the cam member 500, the holder 200 is pushed out of the main body 100. In addition, the cam right sidewall 513 of the cam member 500 reaches the right sidewall of the cam housing 130, thereby limiting the rotation of the cam member 500.

That is, the cam member 500 stops at the unlock position despite the restoring force of the elastic member 600.

The holder 200 discharged outward by the centrifugal force of the cam member 500 is not further discharged outward as the hooking part of the stopper hook 230 is caught by the stopper groove 121 provided on the bottom surface of the main body 100 (refer to FIG. 13).

That is, when the user pulls out the holder 200 until the cam member 500 leaves the neutral position in the unlocking direction from the lock position, the holder 200 is discharged to the exterior of 100 by the restoring force of the elastic member 600.

An auto closing apparatus according to an example is described. In the following description, a same configuration as the above-described example may not be further described.

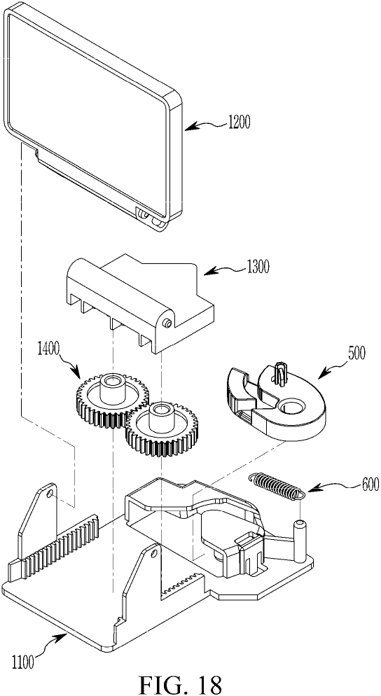

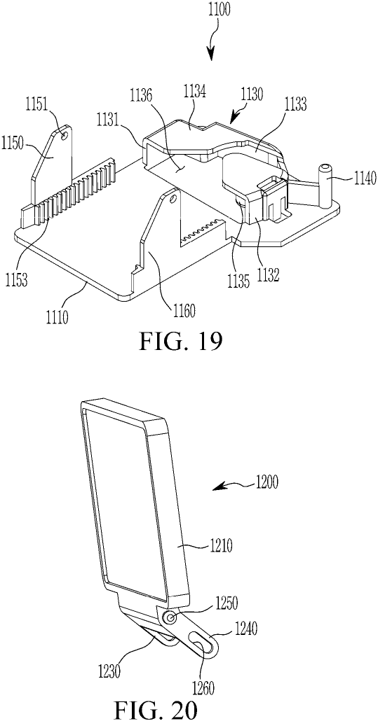

FIG. 17 is a perspective view of an auto closing apparatus of an input/output device according to an example. FIG. 18 is an exploded perspective view of an auto closing apparatus of an input/output device according to an example.

An auto closing apparatus of an input/output device may include a main body 1100, a holder 1200 seated with the input/output device and rotatably connected to the main body 1100, a connection frame 1300 to move in a straight line according to a rotation operation of the holder 1200, a cam member 500 to rotate about a hinge according to a movement of the connection frame 1300, and an elastic member to provide an elastic force to the cam member 500. The cam member 500 and the elastic member 600 are substantially the same as in the above-described example, and are not further described.

An example auto closing apparatus of an input/output device may further include a buffer device to absorb an impact generated during a movement of the connection frame 1300. The buffer device may be implemented by a buffer gear 1400 rotatably coupled to the connection frame and a rack gear coupled to the main body 100 to engage with the buffer gear 1400.

The main body 1100 may form an appearance of the image forming apparatus, and may enclose a printing medium supply apparatus, a printing apparatus, a fusing apparatus, a printing medium discharge apparatus, or the like.

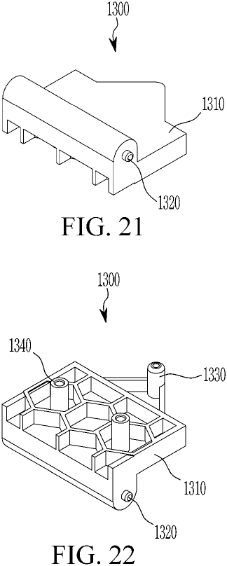

FIG. 19 is a perspective view of a main body of an auto closing apparatus of an input/output device according to an example.

Referring to FIG. 19, an auto closing apparatus may be coupled to an interior of the main body 1100 according to an example, and the holder 1200 may be rotatably connected thereto.

For example, the holder 1200 may rotate to be open or closed relative to the main body 1100.

The main body 1100 may include a body 1110 having a generally planar shape, a left side body 1150 and a right side body 1160 extending upward at both sides of the body 1110, and a cam housing 1130 coupled to the body 1110.

The cam housing 1130 may guide a rotation of the cam member 500, and may perform a function as a limiter for limiting a rotation amount of the cam member 500. The cam housing 1130 may include a pair of housing sidewalls including a housing left sidewall 1131 and a housing right sidewall 1132, a housing rear wall 1133 connecting the pair of housing sidewalls, and a housing upper surface 1134 covering the pair of housing sidewalls and the housing rear wall 1133. An open housing inlet 1136 may be provided between the pair of housing sidewalls such that the cam member 500 may be inserted into the cam housing 1130. A hinge boss 1135 for hinged coupling of the cam member 500 may be provided on the housing upper surface 1134 of the cam housing 1130.

In addition, a main body catching protrusion 1140 for coupling the elastic member 600 may be coupled to the main body 1100. The main body catching protrusion 1140 is substantially the same as the main body catching protrusion 140 in FIG. 5 and is not further described.

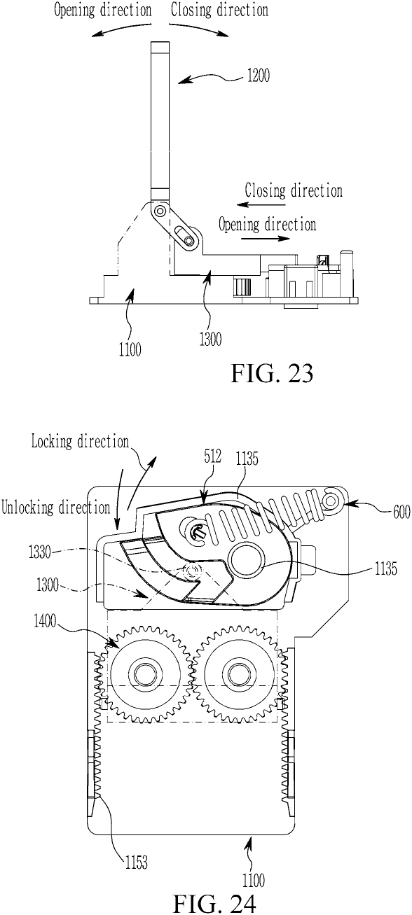

The left side body 1150 and the right side body 1160 may extend at both ends of the body 1110. A rotation hole 1151 may be provided in each of the left and right side bodies 1150 and 1160. A holder rotation boss 1250 (refer to FIG. 20) coupled to the holder 1200 may be inserted into the rotation hole 1151, and the holder 1200 may rotate with respect to the main body 1100.

A rack gear 1153 may be provided on an interior surface of the left side body 1150 and the right side body 1160, respectively. The rack gear 1153 respectively provided on the left side body 1150 and the right side body 1160 may be provided below the rotation hole 1151. For example, the rack gear 1153 may be provided at a position where the body 1110 and the left side body 1150 meet and at a position where the body 1110 and the right side body 1160 meet.

FIG. 20 is a perspective view of a holder of an auto closing apparatus of an input/output device according to an example.

An input/output device may be seated in the holder 1200, and the input/output device may be fixedly coupled to or detachably coupled to the holder 1200. In an example, the input/output device is fixed to the holder 1200 and is integrally formed therewith. In an example, the input/output device may be a display device.

As shown in FIG. 20, the holder 1200 may include a holder body 1210 having a generally planar shape and a holder left side body 1230 and a holder right side body 1240 extending at both ends of the holder body 1210 at a predetermined angle to the rear of holder body 1210.

The holder rotation boss 1250 may be provided at both ends of the holder 1200. For example, the holder rotation boss 1250 may be provided at positions where the holder body 1210 and the holder left and right side bodies 1230 and 1240 meet. The holder rotation boss 1250 may be inserted into the rotation hole 1151 provided in the main body 1100 such that the holder 1200 may rotate with respect to the main body 1100.

The holder 1200 may rotate about the rotation hole 1151 provided in the main body 1100 to reciprocally rotate between a lock position at which the holder 1200 is fully closed with respect to the main body 1100 and an open position at which the holder 1200 is fully open with respect to the main body 1100. In the open position, the holder body 1210 of the holder 1200 may be positioned perpendicularly to the body 1110 of the main body 1100, and in the closed position, the holder body 1210 of the holder 1200 may be positioned in parallel with the body 1110 of the main body 1100. Therefore, in an example, a range between open and closed positions may form a right angle, but is not necessarily limited thereto.

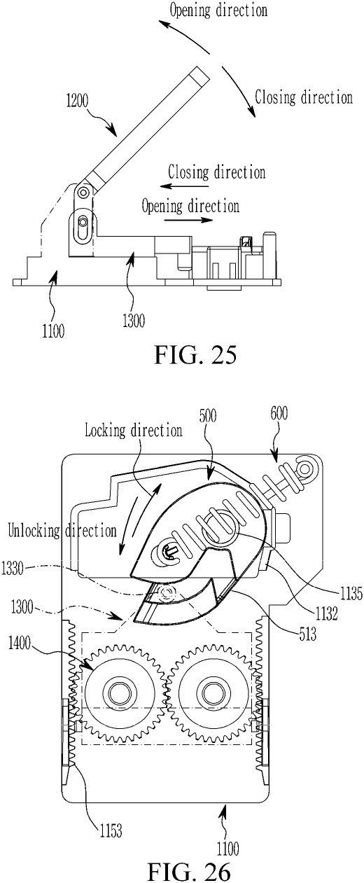

In addition, a holder slot 1260 may be provided in the holder left and right side bodies. The holder slot 1260 may be inserted into a frame rotation boss 1320 (refer to FIG. 21) coupled to the connection frame 1300.

FIG. 21 and FIG. 22 are respective views of a connection frame according to an example. The connection frame 1300 may be provided to move in a straight line according to the rotation operation of the holder 1200.

As shown in FIG. 21 and FIG. 22, the connection frame 1300 may include a frame body 1310, the frame rotation boss 1320 provided at both ends of the frame body 1310, and rear center of the frame body 1310 may include a frame boss 1330 provided at a rear center of the frame body 1310.

The frame rotation boss 1320 may be inserted into the holder slot 1260 provided in the holder 1200 such that the holder 1200 may rotate and the connection frame 1300 may also move straightly in frontward and rearward directions.

For example, since the holder rotation boss 1250 of the holder 1200 is inserted into the rotation hole 1151 of the main body 1100, when the holder 1200 rotates about the rotation hole 1151, an interior surface of the holder slot 1260 provided in the holder 1200 pushes the frame rotation boss 1320 of the connection frame 1300 in the frontward and rearward directions and thereby the connection frame 1300 moves straightly in the frontward and rearward directions.

A frame gear boss 1340 to be rotatably coupled to the buffer gear 1400 may be provided on a bottom of the connection frame 1300.For example, the frame gear boss 1340 may be provided in a pair at the bottom of the connection frame 1300 engaged with the rack gear 1153 of the main body 1100. A pair of buffer gears 1400 rotatably coupled to the connection frame 1300 may be gear-engaged with each other, a buffer gear coupled to a left side of the connection frame 1300 may be gear-engaged with a rack gear coupled to a left side of the main body 1100, and a buffer gear coupled to a right side of the connection frame 1300 may be gear-engaged with a rack gear coupled to a right side of the main body 1100.

The rack gear 1153 and the buffer gear 1400 may function as a buffer device to absorb an impact.

For example, since a pair of buffer gears are engaged with each other and the buffer gear 1400 and the rack gear 1153 are engaged with each other, an impact or a vibration that may occur when the connection frame 1300 moves is absorbed.

In an example, the cam member 500, the cam housing 1130, and the elastic member 600 are substantially the same as described above, and are not further described.

Hereinafter, an operation of an auto closing apparatus according to an example is described. An example operation of the holder 1200 closing with respect to the main body 1100 from an open state with respect to the main body 1100 in an open state will be described.

In an example, the open position of the holder 1200 corresponds with the above-described lock position of the cam member 500, and the closed position of the holder 1200 corresponds with the above-described unlock position of the cam member 500. In addition, the neutral position of the cam member 500 corresponds with the neutral position of the holder 1200.

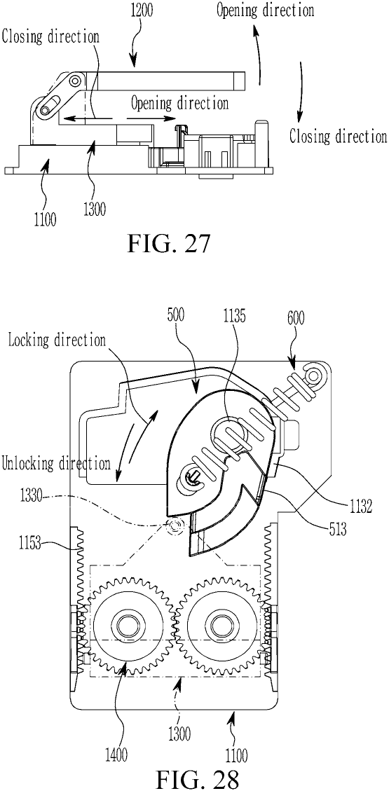

FIG. 23 to FIG. 28 illustrate an operation of an auto closing apparatus of an input/output device according to an example. FIG. 23 and FIG. 24 illustrate a state in which the holder 1200 is rotated to the open position perpendicular to the main body 1100 and the cam member 500 is rotated to the lock position according to the straight line movement of the connection frame 1300. FIG. 25 and FIG. 26 illustrate a state in which the holder 1200 is rotated with respect to the main body 1100 by a predetermined angle and the cam member 500 is rotated to the neutral position according to the movement of the connection frame 1300. FIG. 27 and FIG. 28 illustrate a state in which the holder 1200 is rotated with respect to the main body 1100 to the closed position and the cam member 500 is rotated to the unlock position according to the movement of the connection frame 1300. For reference, the operation of the cam member 500 is substantially the same as the operation of the cam member 500 as described above.

In an example, when the holder 1200 rotates from the open position (refer to FIG. 23) to the closed position (refer to FIG. 27) (i.e., when the holder rotates in the closing direction), the connection frame 1300 moves from the rear to the front (i.e., moves in the locking direction), and the cam member 500 rotates from the lock position to the unlock position. On the contrary, when the holder 1200 rotates from the closed position to the open position (i.e., when the holder rotates in the opening direction), the connection frame 1300 moves from the front to the rear (i.e., moves in the opening direction), and the cam member 500 rotates from the unlock position to the lock position.

Referring to FIG. 23 and FIG. 24, when the user grips the holder body 1210 of the holder 1200 and rotates the holder 1200 toward the body 1110 of the main body 1100 in the closing direction (i.e., clockwise with reference to FIG. 23), the interior surface of the holder slot 1260 provided in the holder 1200 pushes the frame rotation boss 1320 of the connection frame 1300 from the rear to the front (i.e., in the locking direction), and the connection frame 1300 moves frontward. In addition, by the straight line movement of the connection frame 1300, the cam member 500 begins to rotate from the lock position to the unlocking direction. According to the rotation of the cam member 500, the extended length of the elastic member 600 gradually increases and the restoring force of the elastic member 600 gradually increases.

Referring to FIG. 25 and FIG. 26, when the user continues to rotate the holder 1200 in the closing direction, the connection frame 1300 moves in the locking direction according to the rotation of the holder 1200, and the curved range 522 of the cam path 520 rotates following the frame boss 1330.

For example, the cam member 500 rotates in the unlocking direction and the cam member 500 rotates to the neutral position. The elastic member 600 connected to the cam member 500 may be maximally extended such that the restoring force of the elastic member 600 is maximum.

Referring to FIG. 27 and FIG. 28, when the user continues to rotate the holder 1200 in the closing direction, the connection frame 1300 moves in the locking direction according to the rotation of the holder 1200, and the cam member 500 leaves the neutral position. When the cam member 500 begins to leave the neutral position, the cam member 500 may be rotated to the unlock position by the restoring force of the elastic member 600. The frame boss 1330 moves to the feeding range 521 of the cam path 520, and the cam right sidewall 513 of the cam member 500 reaches the housing right sidewall 1132 of the cam housing 1130, thereby limiting the rotation of the cam member 500. Therefore, the rotation of the cam member 500 is limited.

For example, in the case in which the cam member 500 rotates from the lock position in the unlocking direction as the holder 1200 rotates from the open position in the closing direction, when the user rotates the holder 1200 until the cam member 500 leaves the neutral position, the holder 1200 rotates to the closed position by the restoring force of the elastic member 600.

When the holder 1200 rotates from the open position to the closed position, a pair of buffer gears 1400 rotatable in the connection frame 1300 are gear-engaged with the rack gear 1153 coupled to the main body 1100, and therefore an impact or a vibration generated while the connection frame 1300 moves may be reduced.

An example operation of the holder 1200 rotating from the closed position to the open position through the auto closing apparatus will be described. The operation of the holder 1200 rotating from the closed position to the open position with respect to the main body 1100 may be performed in a reverse order of the above-described process of the holder 1200 rotating from the open position to the closed position.

Referring to FIG. 27 and FIG. 28, when the user grips the holder body 1210 of the holder 1200 and rotates the holder 1200 in the opening direction (i.e., counter-clockwise with reference to FIG. 23) with respect to the main body 1100, the interior surface of the holder slot 1260 provided in the holder 1200 pushes the frame rotation boss 1320 of the connection frame 1300 rearward, and the connection frame 1300 moves from the front to the rear (i.e., opening direction).

The frame boss 1330 of the connection frame 1300 moves to the feeding range 521 of the cam path 520 provided in the cam member 500. When the connection frame 1300 moves rearward, the frame boss 1330 moves straightly rearward, and by the straight line movement of the frame boss 1330 inserted into the cam path 520, the cam member 500 begins to rotate about the hinge boss 1135 from the unlock position in the locking direction. According to the rotation of the cam member 500, the extended length of the elastic member 600 gradually increases and the restoring force of the elastic member 600 gradually increases.

Referring to FIG. 25 and FIG. 26, when the user continues to rotate the holder 1200 in the opening direction, the connection frame 1300 continues to move in the rearward direction according to the rotation of the holder 1200, and the curved range 522 of the cam path 520 rotates following the frame boss 1330.

For example, the cam member 500 rotates in the locking direction and the cam member 500 rotates to the neutral position. The elastic member 600 connected to the cam member 500 may be maximally extended such that the restoring force of the elastic member 600 is maximum.

Referring to FIG. 23 and FIG. 24, when the user continues to rotate the holder 1200 in the opening direction, the cam member 500 leaves the neutral position by the frame boss 1330 of the connection frame 1300. When the cam member 500 leaves the neutral position, the cam member 500 rotates to the lock position by the restoring force of the elastic member 600. The frame boss 1330 moves from the curved range 522 of the cam path 520 to the straight range 523, the connection frame 1300 is pushed rearward by a centrifugal force due to the rotation of the cam member 500, and the holder 1200 rotates in the opening direction by the movement the connection frame 1300. In addition, the cam left sidewall 512 of the cam member 500 reaches the housing rear wall 1133 of the cam housing 1130, thereby limiting the rotation of the cam member 500. That is, the cam member 500 stops at the lock position despite the restoring force of the elastic member 600.

For example, when the user rotates the holder 1200 until the cam member 500 leaves the neutral position from the unlock position in the locking direction, the connection frame 1300 moves rearward by the restoring force of the elastic member 600, and the holder 1200 rotates in the opening direction by the movement of the connection frame 1300.

When the holder 1200 rotates from the closed position to the open position, a pair of buffer gears 1400 rotatable in the connection frame 1300 are gear-engaged with the rack gear 1153 coupled to the main body 1100, and therefore an impact or a vibration generated while the connection frame 1300 moves may be reduced.

As described above, in an auto closing apparatus according to an example, the holder seated with an input/output device may be easily discharged from the interior of the main body, or easily inserted into the interior of the main body, by a simple operation of the user. Alternatively, the holder seated with the input/output device may be opened or closed with respect to the main body by a simple operation of the user.

In addition, with one cam member and one elastic member, the holder may be discharged to the exterior of the main body, inserted into the main body, or opened or closed with respect to the main body, thus reducing the manufacturing cost of an image forming apparatus.

In addition, when the input/output device is not used, the input/output device may be inserted into the main body or closed to the main body by a simple operation, thereby achieving a preferred appearance of an image forming apparatus.

While various examples have been described, it is to be understood that the disclosure is not limited thereto. On the contrary, it is intended to cover various modifications and equivalent arrangements included within the spirit and scope of the appended claims.

What is claimed is:

1. An auto closing apparatus, comprising:
a main body having an inlet;
a holder insertable into or dischargeable out of the main body through the inlet;
a cam member to rotate, according to a movement of the holder, between a lock position at which the holder is inserted and an unlock position at which the holder is discharged; and
an elastic member to provide a restoring force for the cam member to rotate between the unlock position and the lock position.

2. The auto closing apparatus of claim 1, wherein the cam member includes a cam path such that the cam member is to rotate by a straight line movement of a holder boss coupled to the holder.

3. The auto closing apparatus of claim 1, wherein the elastic member is to provide a first restoring force at the lock position and the unlock position and a second restoring force at a neutral position between the lock position and the unlock position, the second restoring force being greater than the first restoring force.

4. The auto closing apparatus of claim 3, wherein an end of the elastic member is connected to the main body and an opposite end of the elastic member is connected to the cam member.

5. The auto closing apparatus of claim 1, further comprising a pair of guide members to guide both ends of the holder.

6. The auto closing apparatus of claim 1, further comprising a holder limiter to limit a discharge amount of the holder.

7. The auto closing apparatus of claim 6, wherein the holder limiter comprises:
a stopper hook coupled to the holder; and
a stopper groove provided in the main body to limit the discharge amount of the holder and to which the stopper hook selectively fits.

8. The auto closing apparatus of claim 1, further comprising a cam housing coupled to the main body to guide a rotation of the cam member.

9. The auto closing apparatus of claim 8, further comprising:
a hinge boss coupled to the cam housing; and
a hinge hole provided in the cam member and inserted into the hinge boss.

10. The auto closing apparatus of claim 9, wherein, in the unlock position, one end of the cam member contacts one end of the housing, and in the lock position, another end of the cam member contacts another end of the housing.

11. An auto closing apparatus, comprising:
a main body;
a holder including an input/output device to open and close by being rotatably connected to the main body;
a connection frame movable in a straight line according to a rotation operation of the holder;
a cam member to rotate, according a movement of the connection frame, between a lock position corresponding to a position of opening the holder and an unlock position corresponding to a position of closing the holder; and
an elastic member to provide a restoring force to rotate the cam member between the unlock position and the lock position.

12. The auto closing apparatus of claim 11, further comprising a rotation boss coupled to the holder and inserted into a rotation hole provided in the main body such that the holder is rotatably coupled to the main body.

13. The auto closing apparatus of claim 11, wherein the cam member includes a cam path such that the cam member rotates by a straight line movement of a holder boss coupled to the holder.

14. The auto closing apparatus of claim 13, wherein the elastic member is to provide a first restoring force at the lock position and the unlock position and a second restoring force at a neutral position between the lock position and the unlock position, the second restoring force being greater than the first restoring force.

15. The auto closing apparatus of claim 11, further comprising a buffer device coupled to the connection frame and the main body and to absorb an impact generated during a movement of the connection frame.
